(19) United States
(12) Patent Application Publication
(10) Pub. No.: US 2024/0295737 A1
(43) Pub. Date: Sep. 5, 2024

(54) VARIABLE WORLD BLUR FOR OCCLUSION AND CONTRAST ENHANCEMENT VIA TUNABLE LENS ELEMENTS

(71) Applicant: GOOGLE LLC, Mountain View, CA (US)

(72) Inventors: Timothy Paul Bodiya, Shanghai (CN); Ozan Cakmakci, Sunnyvale, CA (US)

(21) Appl. No.: 18/574,503

(22) PCT Filed: Aug. 26, 2022
(86) PCT No.: PCT/US2022/041624

§ 371 Date: Dec. 27, 2023

Related U.S. Application Data
(60) Provisional application No. 63/237,385, filed on Aug. 26, 2021.

(51) Int. Cl. G02B 27/01; G02B 3/14

(52) U.S. Cl. CPC G02B 27/0172; G02B 3/14; G02B 2027/0118; G02B 2027/0178; G02B 2027/0194

(57) ABSTRACT

Systems, devices, and methods are described in which one or more tunable lens elements are incorporated within a lens structure communicatively coupled to a wearable display device operable to present augmented reality (AR) content to a user. The lens structure includes a display optics lens layer having a provided AR display, one or more eye-side lens layers disposed adjacent to the display optics lens layer and facing an eye of the user, and one or more world-side lens layers disposed adjacent to the display optics lens layer and facing away from the eye of the user. The world-side lens layers includes a tunable lens component to selectively adjust a focal modulation of at least a portion of a real-world view of the user via the lens structure.

### BACKGROUND

In the field of optics, a combiner is an optical apparatus that combines two light sources. For example, light transmitted from a micro-display and directed to a combiner via a waveguide (also termed a lightguide) may be combined with environmental light from the world to integrate content from the micro-display with a view of the real world. Optical combiners are used in heads-up displays (HUDs), examples of which include wearable heads-up displays (WHUDs) and head-mounted displays (HMDs) or near-eye displays, which allow a user to view computer-generated content (e.g., text, images, or video content) superimposed over a user's environment viewed through the HMD, creating what is known as augmented reality (AR). In some applications, an HMD is implemented in an eyeglass frame form factor with an optical combiner forming at least one of the lenses within the eyeglass frame. The HMD enables a user to view the displayed computer-generated content while still viewing their environment.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example wearable display device in accordance with one or more embodiments.

FIG. 2 illustrates an example wearable display device in accordance with one or more embodiments.

FIG. 3 presents a block diagram of a lens structure in accordance with one or more embodiments.

FIG. 4 depicts an example of per-pixel focal modulation in a lens structure for rendering augmented reality content in accordance with one or more embodiments.

FIG. 5 is a block diagram illustrating an overview of operations of a display system in accordance with one or more embodiments.

FIG. 6 is a component-level block diagram illustrating an example of a system suitable for implementing one or more embodiments.

### DETAILED DESCRIPTION

Typical use of a WHUD for presentation of AR content involves one of two scenarios. The first such scenario involves a display of sharply detailed graphical or other AR content, which utilizes high contrast and allows low latency operation-including fast accommodation lock for an eye of the user. Accommodation lock is the adjustment of the optics of the eye in a manner similar to adjusting the focal length of a lens, to keep an object in focus on the retina as its distance from the eye varies or as the object first appears before the user. The second such scenario involves the display of AR content that interacts (or appears to interact) with objects in the real world. As the real world includes objects at a variety of focal depths, the presentation of such AR content typically involves hard or soft occlusion of one or more individual objects, such as to partially or fully occlude them in favor of one or more portions of the AR content.

Various approaches to achieve high-contrast graphical content or variety of focal depths have included pinlight displays, which can simulate occlusion but are limited in transparency and in sharpness; combining optical imagery for the purpose of occlusion, which typically results in a significant increase in display size that is largely incompatible with WHUDs having an eyeglass-style form factor; improving contrast via improved display brightness and performance, which negatively impacts power and weight efficiencies of the associated device.

Embodiments described herein incorporate one or more tunable lens elements on the world side of a WHUD system to blur—that is, to selectively adjust a focal modulation of at least a portion of a real-world view of the user via a lens structure of the WHUD device. The lens structure may include multiple lens layers, each of which may be disposed closer to an eye of the user than optical display elements for presenting AR content (eye side) or further from the eye of the user than those optical display elements (world side).

In various embodiments, tunable lens elements incorporated in a lens structure can include, as non-limiting examples: sliding variable power lenses, electrode-wetting lenses, fluid-filled lenses, dynamic graphene-based lenses, and gradient refractive index liquid crystal lenses. A tunable lens can also be provided through a combination of spherical concave lenses, spherical convex lenses, cylindrical concave lenses, cylindrical convex lenses, and/or prismatic lenses. In certain embodiments, a pixelated tunable lens element may be utilized (either individually or in conjunction with another tunable lens element) to provide focal modulation of the tunable lens element on a pixel-by-pixel basis, and may thereby provide a localized blur around specific objects. In this manner, the incorporating WHUD device may simulate occlusion (hard or soft) of specific real-world objects to provide more realistic imagery within AR content being presented to the user. In various embodiments, a tunable lens element incorporated in a lens structure may include polarized or non-polarized elements, and may be utilized with WHUD device architectures that include flat or curved waveguides/lightguides.

By incorporating a tunable lens and controlling a focal modulation of the tunable lens during display operation, an example WHUD device is able to defocus (to induce blur via focal modulation) some or all of the real world view while preserving details of the AR content display on which the eye is focused. This functionality may be utilized in a variety of manners. As one example, the background real world view may be defocused to reduce visual clutter in order to enhance contrast. As another example, a slight blur may be introduced via defocusing the tunable lens element(s) to assist in accommodation lock for the eye of the user. As another example, an object to be displayed within the AR content may be shifted to a similar focal plane as an object in the real world, such as to assist (e.g., in combination with contextual sensors that sense gaze direction) in quick accommodation lock. In certain embodiments, this focal plane shifting (also termed distance shift) may utilize aspects of Simultaneous Localization and Mapping (SLAM) techniques, in which the WHUD device determines its position in the world by determining the spatial relationship between itself and multiple known or identified environmental positions.

It will be appreciated that while particular embodiments discussed herein involve utilizing optical or other components as part of a wearable display device, additional embodiments may utilize such components via various other types of devices in accordance with techniques described herein.

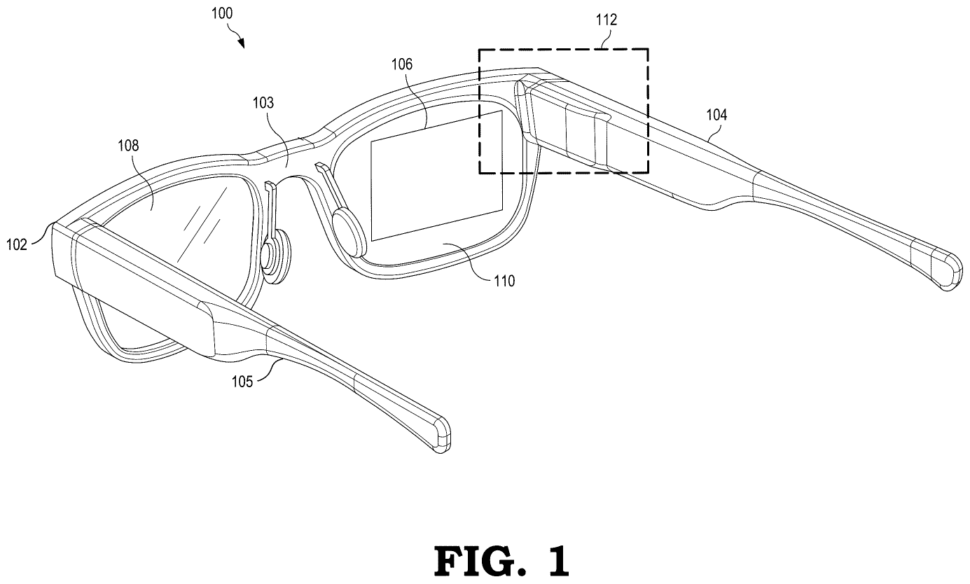

FIG. 1 illustrates an example wearable display device 100 in accordance with various embodiments. In the depicted embodiment, the wearable display device 100 is a near-eye display system having a general shape and appearance (that is, form factor) of an eyeglasses (e.g., sunglasses) frame. The wearable display device 100 includes a support structure 102 that includes a first arm 104, a second arm 105, and a front frame 103, which is physically coupled to the first arm 104 and the second arm 105. When worn by a user, the first arm 104 may be positioned on a first side of a head of the user, while the second arm 105 may be positioned on a second side of the head of the user opposite to the first side of the head of the user, and the front frame 103 may be positioned on a front side of the head of the user. In the depicted embodiment, the support structure 102 houses a light engine (e.g., a laser projector, a micro-LED projector, a Liquid Crystal on Silicon (LCOS) projector, or the like) that is configured to project images toward the eye of a user via a waveguide. The user perceives the projected images as being displayed in a field of view (FOV) area 106 of a display at one or both of lens structures 108, 110 via one or more optical display elements of the wearable display device 100. In some embodiments, the light engine also generates infrared light, such as for eye tracking purposes.

The support structure 102 contains or otherwise includes various components to facilitate the projection of such images toward the eye of the user, such as a light engine and a waveguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the wearable display device 100. In some embodiments, some or all of these components of the wearable display device 100 are fully or partially contained within an inner volume of support structure 102, such as within the first arm 104 in region 112 of the support structure 102. It should be noted that while an example form factor is depicted, it will be appreciated that in other embodiments the wearable display device 100 may have a different shape and appearance from the eyeglasses frame depicted in FIG. 1. It should be understood that instances of the term “or” herein refer to the non-exclusive definition of “or”, unless noted otherwise. For example, as used herein the phrase “X or Y” means “either X, or Y, or both.”

One or both of the lens structures 108, 110 are used by the wearable display device 100 to provide an augmented reality (AR) display in which rendered graphical content can be superimposed over or otherwise provided in conjunction with a real-world view as perceived by the user through the lens structures 108, 110. For example, a projection system of the wearable display device 100 uses light to form a perceptible image or series of images by projecting the light onto the eye of the user via a light engine of the projection system, a waveguide formed at least partially in the corresponding lens structure 108 or 110, and one or more optical display elements, according to various embodiments. In some embodiments, the wearable display device 100 is symmetrically configured such that lens structure 108 is also a combiner, with a light engine housed proximate to the lens structure 108 in a portion of the support structure 102 (e.g., within arm 105 or in front frame 103) to project images to a FOV area within the lens structure 108. Either or both of lens structures 108, 110 can be configured with eye-side and world-side surfaces having curvatures that in combination provide prescription correction of light that is transmitted to a user's eye(s).

In various embodiments, the optical display elements of the wearable display device 100 include one or more instances of optical components selected from a group that includes at least: a waveguide (references to which, as used herein, include and encompass both light guides and waveguides), holographic optical element, prism, diffraction grating, light reflector, light reflector array, light refractor, light refractor array, collimation lens, scan mirror, optical relay, or any other light-redirection technology as appropriate for a given application, positioned and oriented to redirect AR content from the light engine towards the eye of the user. Moreover, some or all of the lens structures 108, 110 and optical display elements may individually and/or collectively comprise an optical substrate in which one or more structures may be formed. For example, the optical display elements may include various optical gratings (whether as an incoupler grating, outcoupler grating, or intermediate grating) formed in an optical substrate material of the lens structures 108, 110.

One or both of the lens structures 108, 110 includes at least a portion of a waveguide that routes display light received by an incoupler of the waveguide to an outcoupler of the waveguide, which outputs the display light toward an eye of a user of the wearable display device 100. The display light is modulated and projected onto the eye of the user such that the user perceives the display light as an image. In addition, each of the lens structures 108, 110 is sufficiently transparent to allow a user to see through the lens structures to provide a field of view of the user's real-world environment such that the image appears superimposed over at least a portion of the real-world environment.

Each of the lens structures 108, 110 includes multiple lens layers, each of which may be disposed either closer to or further from an eye of the user with respect to one or more optical display elements of the lens structure that are used to present AR content (eye side or world side, respectively). A lens layer can, for example, be molded or cast, may include a thin film or coating, and may include one or more transparent carriers, which as described herein may refer to a material which acts to carry or support an optical redirector. As one example, a transparent carrier may be an eyeglasses lens or lens assembly. In addition, in certain embodiments one or more of the lens layers may be implemented as a contact lens.

In some embodiments, the light engine of the projection system of the wearable display device 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the light engine includes a micro-display panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the light engine includes a Liquid Crystal on Silicon (LCOS) display panel. In some embodiments, a display panel of the light engine is configured to output light (representing an image or portion of an image for display) into the waveguide of the display system. The waveguide expands the light and outputs the light toward the eye of the user via an outcoupler.

The light engine is communicatively coupled to the controller and a non-transitory processor-readable storage medium or memory storing processor-executable instructions and other data that, when executed by the controller, cause the controller to control the operation of the light engine. In some embodiments, the controller controls the light engine to selectively set the location and size of the FOV area 106. In some embodiments, the controller is communicatively coupled to one or more processors (not shown) that generate content to be displayed at the wearable display device 100. The light engine outputs light toward the FOV area 106 of the wearable display device 100 via the waveguide. In some embodiments, at least a portion of an outcoupler of the waveguide overlaps the FOV area 106.

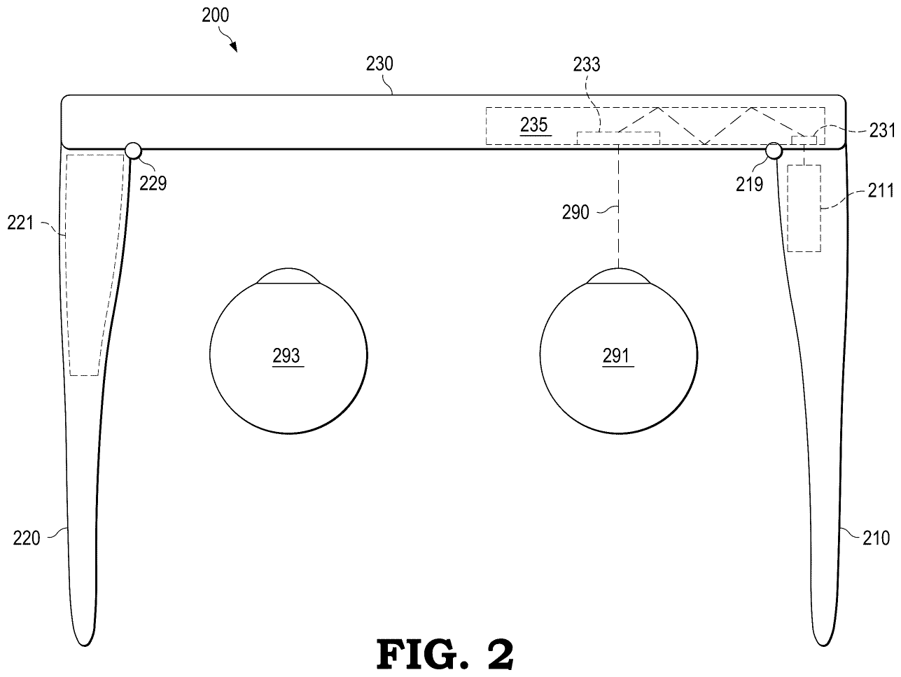

FIG. 2 illustrates a diagram of a wearable display device 200 in accordance with some embodiments. In some embodiments, the wearable display device 200 may implement or be implemented by aspects of the wearable display device 100. For example, the wearable display device 200 may include a first arm 210, a second arm 220, and a front frame 230. The first arm 210 may be coupled to the front frame 230 by a hinge 219, which allows the first arm 210 to rotate relative to the front frame 230. The second arm 220 may be coupled to the front frame 230 by the hinge 229, which allows the second arm 220 to rotate relative to the front frame 230.

In the example of FIG. 2, the wearable display device 200 may be in an unfolded configuration, in which the first arm 210 and the second arm 220 are rotated such that the wearable display device 200 can be worn on a head of a user, with the first arm 210 positioned on a first side of the head of the user, the second arm 220 positioned on a second side of the head of the user opposite the first side, and the front frame 230 positioned on a front of the head of the user. The first arm 210 and the second arm 220 can be rotated towards the front frame 230, until both the first arm 210 and the second arm 220 are approximately parallel to the front frame 230, such that the wearable display device 200 may be in a compact shape that fits conveniently in a rectangular, cylindrical, or oblong case. Alternatively, the first arm 210 and the second arm 220 may be fixedly mounted to the front frame 230, such that the wearable display device 200 cannot be folded.

In FIG. 2, the first arm 210 carries a light engine 211. The second arm 220 carries a power source 221. The front frame 230 carries display optics 235 including an incoupling optical redirector 231, an outcoupling optical redirector 233, and at least one set of electrically conductive current paths, which provide electrical coupling between the power source 221 and electrical components (such as the light engine 211) carried by the first arm 210. Such electrical coupling could be provided indirectly, such as through a power supply circuit, or could be provided directly from the power source 221 to each electrical component in the first arm 210. As used herein, the terms carry, carries or similar do not necessarily dictate that one component physically supports another component. For example, it is stated above that the first arm 210 carries the light engine 211. This could mean that the light engine 211 is mounted to or within the first arm 210, such that the first arm 210 physically supports the light engine 211. However, it could also describe a direct or indirect coupling relationship, even when the first arm 210 is not necessarily physically supporting the light engine 211.

The light engine 211 can output a display light 290 representative of AR content or other display content to be viewed by a user. The display light 290 can be redirected by display optics 235 towards an eye 291 of the user, such that the user can see the AR content. The display light 290 from the light engine 211 impinges on the incoupling optical redirector 231 and is redirected to travel in a volume of the display optics 235, where the display light 290 is guided through the light guide, such as by total internal reflection or light guide surface treatments like holograms or reflective coatings. Subsequently, the display light 290 travelling in the volume of the display optics 235 impinges on the outcoupling optical redirector 233, which redirects the display light 290 out of the light guide redirector and towards the eye 291 of a user.

The wearable display device 200 may include a processor (not shown) that is communicatively coupled to each of the electrical components in the wearable display device 200, including but not limited to the light engine 211. The processor can be any suitable component which can execute instructions or logic, including but not limited to a micro-controller, microprocessor, multi-core processor, integrated-circuit, ASIC, FPGA, programmable logic device, or any appropriate combination of these components. The wearable display device 200 can include a non-transitory processor-readable storage medium, which may store processor readable instructions thereon, which when executed by the processor can cause the processor to execute any number of functions, including causing the light engine 211 to output the display light 290 representative of display content to be viewed by a user, receiving user input, managing user interfaces, generating display content to be presented to a user, receiving and managing data from any sensors carried by the wearable display device 200, receiving and processing external data and messages, and any other functions as appropriate for a given application. The non-transitory processor-readable storage medium can be any suitable component, which can store instructions, logic, or programs, including but not limited to non-volatile or volatile memory, read only memory (ROM), random access memory (RAM), FLASH memory, registers, magnetic hard disk, optical disk, or any combination of these components.

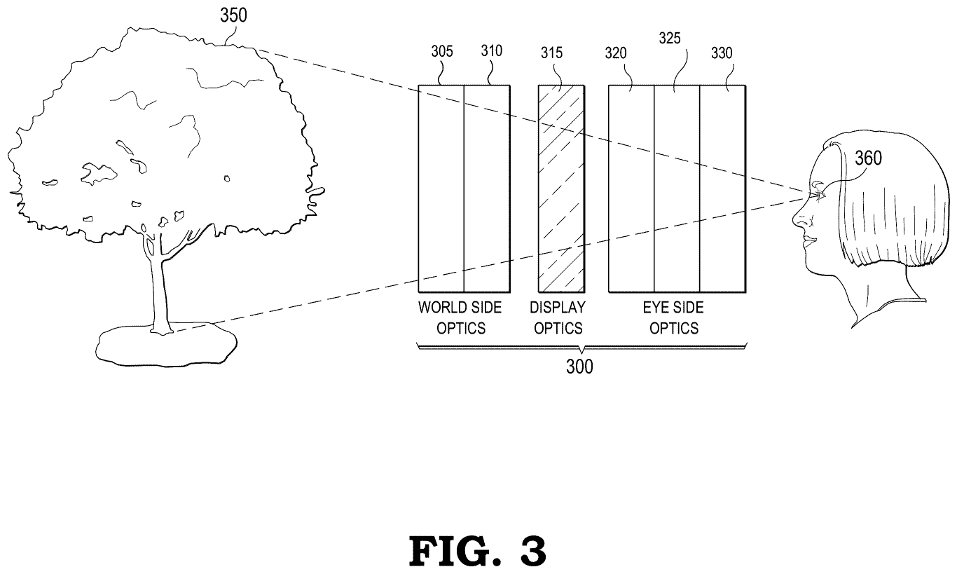

FIG. 3 presents a block diagram of a lens structure 300 in accordance with one or more embodiments. The lens structure 300 may, for example, be used as a single “lens” for use as part of the wearable display device 100 of FIG. 1 and/or wearable display device 200 of FIG. 2.

Each particular lens layer of a lens structure (e.g., lens structure 300) may be referred to as either World Side (WS) or Eye Side (ES), depending on its relative position with respect to any display optics included in the overall lens structure. An AR implementation of a lens structure in accordance with one or more embodiments described herein may be generally represented as one or more lens layers of world side optics, followed by display optics (DO), followed by one or more lens layers of eye side optics. Because WS layers are located beyond the user's view of the DO layer, only ES layers affect the user's perception of the AR content conveyed via the display optics.

As used herein, display optics generally refers to one or more presentation elements used to introduce AR content into a user's field of view, typically via a wearable display assembly such as eyeglasses. In certain embodiments, for example, a lens structure of a display assembly (also referred to herein as a lens “stack” or lens display stack) may include multiple lens layers, with one or more display optics (e.g., one or more optical redirector elements) disposed between such lens layers to produce a heads-up display (HUD) for presenting AR content or other display content.

In the depicted embodiment, the lens structure 300 includes a display optics (DO) layer 315. The lens structure 300 further includes three lens layers (320, 325, and 330, respectively) disposed on the “eye side” of the DO layer 315, indicating that they are disposed between the DO layer and an eye 360 of a user; and two lens layers (305 and 310, respectively) disposed on the “world side” of the DO layer, indicating that they are disposed between the DO layer and the real world 350 (the physical world viewed by the user and which physically exists beyond the display assembly). During use of the lens structure, the user's view of the real world 350 is filtered through any light-directing components of each of the lens layers of the lens structure 300. As noted above, the user's perception of the AR content presented via the DO layer 315 is affected only by the eye side layers (lens layers 305 and 310), while the user's perception of the real world 350 is affected by both the eye side layers and the world side layers (lens layers 305 and 310).

In certain embodiments, the tunable lens layer 310 may be a pixelated tunable lens element (such as a pixel-addressable liquid crystal lens) such that individual addressable portions of the tunable lens layer 310 may be selectively controlled to provide disparate amounts of optical power. Thus, in certain scenarios, the tunable lens layer 310 may be used to selectively adjust a focal modulation of only a portion of the real-world view of a user, such as to blur a portion of the real-world view that is visually proximate to a virtual object included in AR content displayed by an incorporating WHUD device. For example, a portion of the real-world view may be slightly blurred based on a contrast ratio associated with the virtual object, such as to assist the eye of the user in achieving accommodation lock on textual or other content with a relatively high contrast ratio. As another example, a portion of the real-world view may be selectively blurred based on a focal plane of a real-world object at least partially included in that portion. In this manner, the real-world object may be partially or fully occluded in favor of one or more virtual objects overlaid on the user's real world view.

A display shift (DS) is a perceived shift integrated into such a lens structure in order to affect the user-perceived display distance of the AR content introduced in this manner. With no display shift, the AR content is typically perceived as being located at infinity—that is, at a relative infinite distance from the user, such as how stars appear when viewing the night sky. As display shift is added, the AR content is instead perceived to be located at finite distances from the user. Typically, such display shift only impacts the perceived distance of the AR content, rather than that of objects within the real world.

As one illustrative example, assume that rather than appearing as if it were located at an infinite distance from the user, it is desirable to place the AR content in the user's vision as if it were located at a distance of two meters from the user. In order to do so, an eye-side display shift (ESS) of −0.5 diopter power may be used (diopter is a unit of refractive power equal to the reciprocal of the focal length in meters). However, that −0.5 diopter power will result in the user having a blurred perception of the real world beyond the user's eyewear. Therefore, an optically opposed world-side display shift (WSS) of +0.5 diopter power may be used to counter the ESS, placing the AR content at a perceived distance of 2 m without otherwise affecting the user's focus on the real world.

In the depicted embodiment, the world-side optics of the lens structure 300 includes a tunable lens layer 310. In certain scenarios, the tunable lens layer 310 may provide a focal modulation equivalent to an additional selectable amount of optical power (e.g., from −1 to +2 diopters of optical power) that may selectively supplement a static amount of distance shift provided by other layers of the lens structure 300. For example, the AR content provided via the DO layer 315 may be statically distance-shifted to a user-perceived focal plane approximately 2 m from the user's eye 360 via a world-side DS layer 305 in combination with an eye-side DS layer 320. However, by actuating the tunable lens layer 310, the incorporating WHUD device may dynamically select to adjust the display distance at which the AR content is perceived by the user.

In such embodiments, the incorporating WHUD device may actively control a focal plane at which each of multiple virtual objects are presented to the user, with such focal planes deviating by a controllable amount from the static amount of distance shift provided by other layers of the lens structure 300. In this manner, a focal plane of a virtual object may be adjusted in order to substantially match a focal plane at which a real-world object appears, such as to allow perceived interaction of the virtual object with (or modification of) the real-world object. Moreover, certain embodiments may utilize an additional tunable lens layer (such as by using a tunable lens component for eye-side lens layer 325), allowing greater control over the perceived display distance of some or all of the AR content.

It will be appreciated that in various embodiments, the lens structure 300 may incorporate other arrangements of world-side and eye-side lens layers. For example, the lens structure 300 may incorporate a first non-addressable tunable lens layer to apply a selectable amount of focal modulation across an entirety of the lens structure 300 (consequently affecting the entirety of the real-world view presented to the user), and further incorporate a second addressable tunable lens layer to apply variable amounts of focal modulations across one or more selected portions of that real-world view.

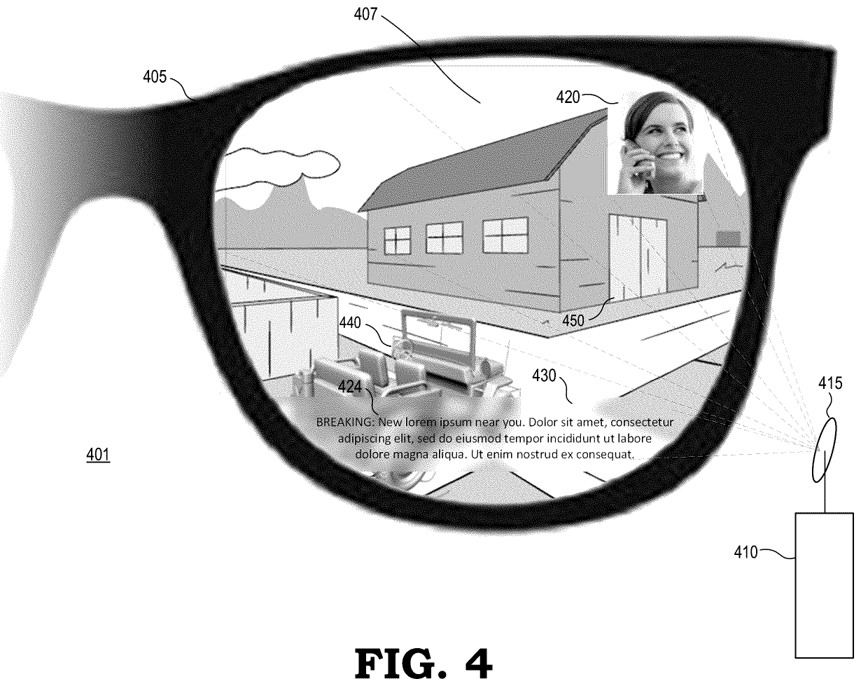

FIG. 4 depicts an example of per-pixel focal modulation in a lens structure 407 for rendering AR content in accordance with one or more embodiments. In the depicted embodiment, an eyeglass-carried display system 401 includes a frame 405 and a light engine 410 coupled to a scanning redirection system (e.g., one or more scanning mirrors) 415.

In the depicted embodiment, the lens structure 407 includes a tunable lens layer (not separately shown) capable of implementing per-pixel focal modulation to effectuate one or more blur configurations, such as to blur some or all of the real-world viewed by a user via the display system 401. In the depicted embodiment, a portion of photographic AR content 420, is identified by the display system 401 as having a relatively low contrast ratio. In contrast, a portion of textual AR content 425 is identified by the display system 401 as having a relatively high contrast ratio.

Based at least in part on the relatively high contrast ratio of the AR content 425, the display system 401 determines to apply a focal modulation via its tunable lens layer to blur pixels within a surrounding area 430 that is proximate to the AR content 425. In certain embodiments and scenarios, the focal modulation applied by the display system 401 comprises a defined blur configuration associated with the AR content 425. For example, the display system 401 may determine an appropriate defined blur configuration to apply via focal modulation based on the contrast ratio of the received AR content, based on the AR content to be displayed being textual or some other identified type of content, etc. In certain embodiments, the display system may store one or more predefined blur configurations associated with various criteria used by the display system 401 when evaluating portions of AR content received for display.

In certain scenarios, the display system 401 may determine to selectively adjust the focal modulation corresponding to other portions of the real-world view visible to the user via the lens structure 407. For example, one or more portions of a vehicle 440 may be partially or fully occluded in favor of one or more virtual objects presented by the lens structure 407, such as to present a virtual character or other virtual object to the user as if that virtual character was riding in the vehicle 440. As another example, an assistive mapping application may utilize the display system 401 to selectively blur (and thereby partially or fully occlude) some or all of a building entrance 450, such as to highlight or otherwise draw attention to the building entrance by overlaying virtual components (e.g., a neon sign or other visually attractive component) on the building entrance 450.

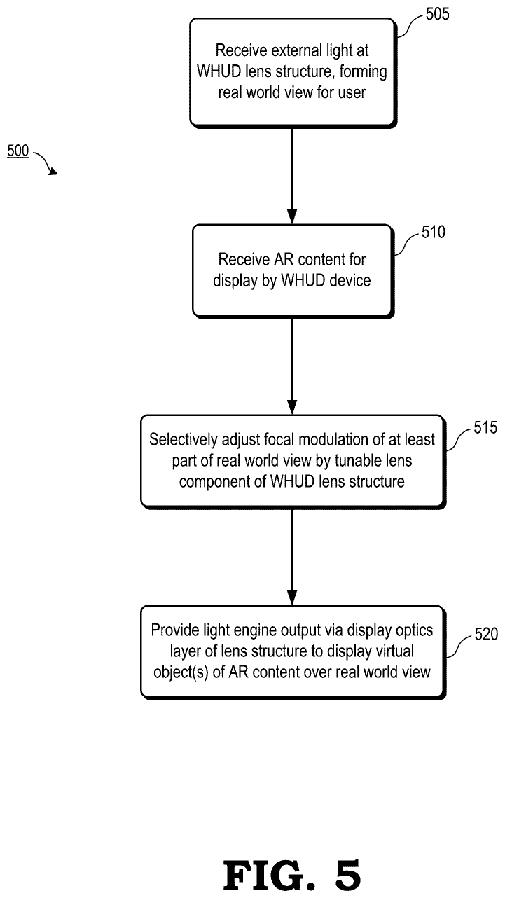

FIG. 5 is a block diagram illustrating an overview of an operational routine 500 of a processor-based display system in accordance with one or more embodiments. The routine may be performed, for example, by an embodiment of wearable display device 100 of FIG. 1, by one or more components of system 700 of FIG. 7, or by some other embodiment.

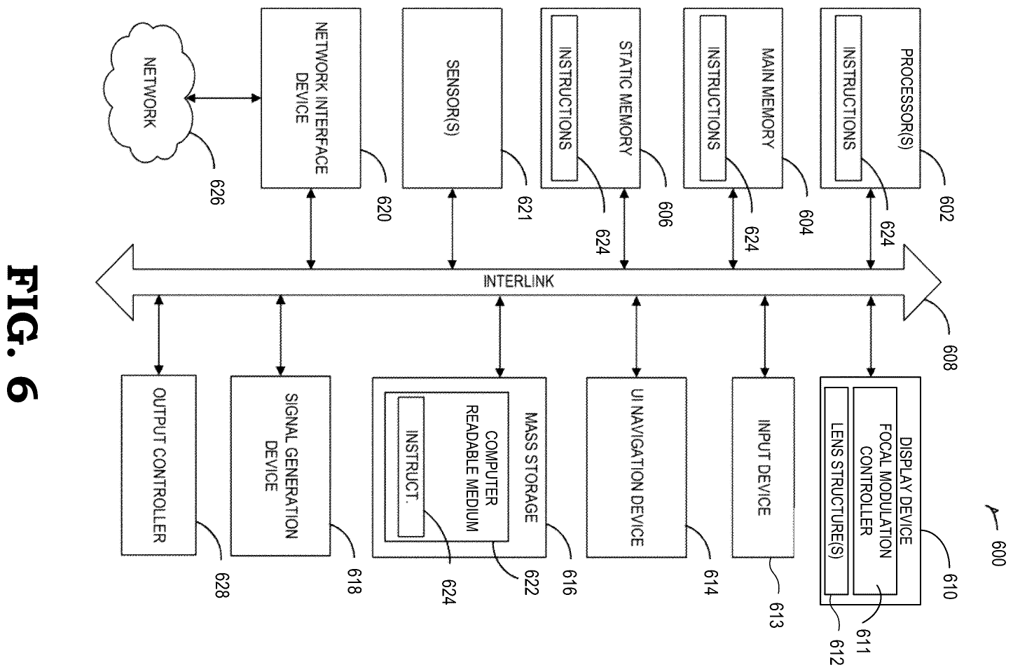

The routine begins at block 505, in which the processor-based display system receives external light that forms a real-world view of a user at a lens structure of the processor-based display system (e.g., lens structure 110 of FIG. 1, lens structure 300 of FIG. 3, lens structure 407 of FIG. 4, lens structure(s) 612 of FIG. 6, etc.). The routine proceeds to block 510.

At block 510, the processor-based display system receives AR content for display. As discussed elsewhere herein, such AR content may include one or more virtual objects for display at one or more focal distances (focal planes) with respect to the user. The routine proceeds to block 515.

At block 515, the processor-based display system selectively adjusts a focal modulation of at least part of the real-world view formed by the external light received in block 505. As discussed elsewhere herein, in various scenarios and embodiments the focal modulation selectively adjusted by the processor-based display system may be based at least in part on a contrast ratio associated with one or more virtual objects to be displayed, on a focal plane or other characteristics of one or more real world objects, or other criteria. The routine proceeds to block 520.

At block 520, the processor-based display system provides output of the light engine via a display optics layer of the lens structure in order to present the received AR content for the user, such as via a light engine (e.g., light engine 211 of FIG. 2 or light engine 410 of FIG. 4) incorporated by and/or communicatively coupled to the processor-based display system.

FIG. 6 is a component-level block diagram illustrating an example of a system 600 suitable for implementing one or more embodiments. In alternative embodiments, the system 600 may operate as a standalone device or may be connected (e.g., networked) to other systems. In various embodiments, one or more components of the system 600 may be incorporated within a head wearable display or other wearable display to provide various types of graphical content and/or textual content. It will be appreciated that an associated HWD device may include some components of system 600, but not necessarily all of them. In a networked deployment, the system 600 may operate in the capacity of a server machine, a client machine, or both in server-client network environments. In an example, the system 600 may act as a peer system in peer-to-peer (P2P) (or other distributed) network environment. The system 600 may be a personal computer (PC), a tablet PC, a set-top box (STB), a personal digital assistant (PDA), a mobile telephone, a web appliance, a network router, switch or bridge, or any system capable of executing instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

System 600 (e.g., a mobile or fixed computing system) may include one or more hardware processors 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The system 600 may further include a display device 610 (such as a light engine) comprising a focal modulation controller 611 and one or more lens structures 612, an alphanumeric input device 613 (e.g., a keyboard or other physical or touch-based actuators), and a user interface (UI) navigation device 614 (e.g., a mouse or other pointing device, such as a touch-based interface). In one example, the display unit 610, input device 613, and UI navigation device 614 may comprise a touch screen display. The system 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The system 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a computer readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the system 600. In an example, one or any combination of the hardware processor 602, the main memory 604, the static memory 606, or the storage device 616 may constitute computer readable media.

While the computer readable medium 622 is illustrated as a single medium, the term “computer readable medium” may include a single medium or multiple media (e.g., a centralized or distributed database, and/or associated caches and servers) configured to store the one or more instructions 624.

The term “computer readable medium” may include any medium that is capable of storing, encoding, or carrying instructions for execution by the system 600 and that cause the system 600 to perform any one or more of the techniques of the present disclosure, or that is capable of storing, encoding or carrying data structures used by or associated with such instructions. Non-limiting computer readable medium examples may include solid-state memories, and optical and magnetic media. In an example, a massed computer readable medium comprises a computer readable medium with a plurality of particles having invariant (e.g., rest) mass. Accordingly, massed computer readable media are not transitory propagating signals. Specific examples of massed computer readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the system 600, and includes digital or analog communications signals or other intangible medium to facilitate communication of such software.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A lens structure having multiple lens layers, the lens structure comprising:
a display optics (DO) lens layer comprising an augmented reality (AR) display, the DO lens layer having a first side for facing an eye of a user and a second side for facing away from the eye of the user;
one or more eye-side (ES) lens layers disposed adjacent to the first side of the DO lens layer; and
one or more world-side (WS) lens layers disposed adjacent to the second side of the DO lens layer, wherein at least one lens layer of the one or more WS lens layers includes a tunable lens component to selectively adjust a focal modulation of at least a portion of a real-world view of the user via the lens structure.

2. The lens structure of claim 1, wherein to selectively adjust the focal modulation of at least a portion of the real-world view of the user comprises to defocus a portion of the real-world view that is visually proximate to a virtual object presented by the AR display.

3. The lens structure of claim 2, wherein to defocus the portion of the real-world view comprises to defocus the portion based on a contrast ratio associated with the virtual object.

4. The lens structure of claim 2, wherein to defocus the portion of the real-world view comprises to defocus the portion of the real-world view based on a focal plane of a real-world object at least partially included in the portion of the real-world view.

5. The lens structure of claim 1, wherein to selectively adjust the focal modulation includes to selectively adjust the focal modulation to adjust a focal plane at which one or more virtual objects are presented by the AR display.

6. The lens structure of claim 5, wherein the focal plane at which the one or more virtual objects are presented is a first focal plane, and wherein to adjust the first focal plane includes to adjust the first focal plane based on a second focal plane at which a real-world object appears in the real-world view.

7. The lens structure of claim 1, wherein:
a first ES lens layer of the one or more ES lens layers includes a first distance shift (DS) component;
the one or more WS lens layers includes multiple WS lens layers; and
one WS lens layer of the multiple WS lens layers includes a second DS component that has a substantially equal but opposite optical power as the first DS component.

8. The lens structure of claim 1, wherein the tunable lens component comprises one or more of a group that includes a sliding variable power lens, an electrode-wetting lens, a fluid-filled lens, a graphene-based variable lens, or a liquid crystal lens.

9. The lens structure of claim 1, wherein the AR display comprises a plurality of individual pixels, and wherein to selectively adjust a focal modulation of at least a portion of a real-world view of the user includes to adjust a focal modulation associated with each of one or more individual pixels of the plurality of individual pixels.

10. The lens structure of claim 1, wherein to selectively adjust a focal modulation of at least a portion of the real-world view includes to defocus a substantial entirety of the real-world view.

11. A method, comprising:
receiving external light that forms a real-world view of a user at a lens structure of a wearable heads-up display (WHUD) device, the lens structure including a display optics (DO) lens layer comprising an augmented reality (AR) display;
coupling light generated at a light engine into a waveguide of the DO lens layer to form one or more virtual objects overlaid on the real-world view of the user; and
selectively adjusting, by a tunable lens component of the lens structure, a focal modulation of at least a portion of the real-world view of the user.

12. The method of claim 11, wherein selectively adjusting the focal modulation of at least a portion of the real-world view includes defocusing a portion of the real-world view that is visually proximate to at least one of the one or more virtual objects.

13. The method of claim 12, wherein defocusing the portion of the real-world view includes defocusing the portion based on a contrast ratio associated with the at least one virtual object.

14. The method of claim 12, wherein defocusing the portion of the real-world view includes defocusing the portion of the real-world view based on a focal plane of a real-world object at least partially included in the portion of the real-world view.

15. The method of claim 11, wherein selectively adjusting the focal modulation includes selectively adjusting the focal modulation based on a focal plane at which one or more virtual objects are presented by the AR display.

16. The method of claim 15, wherein the focal plane at which the one or more virtual objects are presented is a first focal plane, and wherein adjusting the focal modulation based on the first focal plane includes adjusting the first focal plane based on a second focal plane at which a real-world object appears in the real-world view.

17. The method of claim 11, wherein the AR display comprises a plurality of individual pixels, and wherein selectively adjusting the focal modulation of at least the portion of the real-world view includes selectively adjusting a focal modulation associated with each of one or more individual pixels of the plurality of individual pixels.

18. The method of claim 11, wherein adjusting the focal modulation of at least a portion of the real-world view includes defocusing a substantial entirety of the real-world view.

19. A head wearable display (HWD) device that includes a lens structure having multiple lens layers, the lens structure comprising:
a display optics (DO) lens layer comprising an augmented reality (AR) display, the DO lens layer having a first side for facing an eye of a user and a second side for facing away from the eye of the user;
one or more eye-side (ES) lens layers disposed adjacent to the first side of the DO lens layer; and
one or more world-side (WS) lens layers disposed adjacent to the second side of the DO lens layer, wherein at least one of the one or more WS lens layers includes a tunable lens component to selectively adjust a focal modulation of at least a portion of a real-world view of the user via the lens structure.

20. The HWD device of claim 19, wherein to selectively adjust the focal modulation of at least a portion of the real-world view of the user includes to defocus a portion of the real-world view that is visually proximate to a virtual object presented by the AR display.
